(19) United States
(12) Patent Application Publication
(10) Pub. No.: US 2026/0133835 A1
(43) Pub. Date: May 14, 2026

(54) METHOD AND SYSTEM FOR GENERATING RECOMMENDATIONS TO OPTIMIZE RESOURCE UTILIZATION

(71) Applicant: JPMorgan Chase Bank, N.A., New York, NY (US)

(72) Inventors: Huzefa RANGWALA, Mumbai (IN); Rohit S. SHARMA, Thane (IN); Iyyappan VADIYAR, Mumbai (IN); Sanjay RAO, Thane (IN)

(73) Assignee: JPMorgan Chase Bank, N.A., New York, NY (US)

(21) Appl. No.: 19/008,159

(22) Filed: Jan. 2, 2025

(30) Foreign Application Priority Data
Nov. 12, 2024 (IN) 202411087100

(51) Int. Cl. G06F 9/50; G06F 21/31

(52) U.S. Cl. CPC G06F 9/5027; G06F 21/31

(57) ABSTRACT

A system and method for generating recommendations to optimize resource utilization are disclosed. The method includes receiving a recommendation request for a job task based upon successful validation of login credentials of a user. Next, the method includes fetching, from a server by using a token, job data for the job task. Next, the method includes extracting a set of parameters from the job data and analyzing the set of parameters. Next, the method includes detecting a presence of anomalies in the set of parameters based on the analysis of the set of parameters. Next, the method includes identifying underutilized host(s) and non-overlapping time slots for the job task based upon the detection of anomalies. Next, the method includes generating and transmitting, to a user device at least one recommendation for optimizing the resource utilization with respect to the job task.

### CROSS-REFERENCE TO RELATED APPLICATIONS

This application claims priority benefit from Indian Application No. 202411087100, filed on Nov. 12, 2024 in the India Patent Office, which is hereby incorporated by reference in its entirety.

### FIELD OF THE DISCLOSURE

This technology relates to resource management, and more particularly relates to a system and a method for generating recommendations to optimize resource utilization.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In modern computing environments, efficient resource utilization is critical for maximizing performance and minimizing costs. In large-scale organizations (also referred to herein as large organizations) with diverse lines of business (LOB), the reliance on technology solutions such as computing environments is necessary. This reliance brings with it significant challenges for technology teams belonging to different departments, including monitoring for failures, maintaining infrastructure, and managing processes that range from high to low complexity.

The primary challenge faced by technology teams (also referred to herein as tech teams) in the large organizations is a lack of proactive insights and recommendations from existing solutions. Existing solutions are typically report-based, providing statistics without offering guidance on the next steps for optimizing resources (e.g., hosts or computers or servers and licenses) of such organizations. Additionally, existing solutions fail to integrate with various frameworks used by various tech teams within an organization, hence failing to provide customized views specific to different lines of business (LOB). Further, manual intervention to redistribute resources may lead to inefficiencies and potential downtime.

Hence, in view of these and other existing limitations, there arises an imperative need to provide an efficient solution to overcome the above-mentioned limitations and to provide a system or method for efficient optimization of resources within a large organization.

### SUMMARY

The present disclosure, through one or more of its various aspects, embodiments, and/or specific features or sub-components, provides, inter alia, various systems, servers, devices, methods, media, programs, and platforms to generate recommendations to optimize resource utilization.

According to an aspect of the present disclosure, a method for generating recommendations to optimize resource utilization is disclosed. The method is implemented by at least one processor. The method includes receiving, by the at least one processor, a recommendation request for at least one job task based upon successful validation of login credentials of a user. Next, the method includes generating, by the at least one processor, a token to process the recommendation request. Next, the method includes fetching, from a server by the at least one processor using the token, job data for the at least one job task. Next, the method includes extracting, by the at least one processor, a set of parameters from the job data. Next, the method includes analyzing, by the at least one processor, the set of parameters. Next, the method includes detecting, by the at least one processor, a presence of at least one anomaly in the set of parameters based on a result of the analyzing of the set of parameters. Next, the method includes identifying, by the at least one processor, at least one underutilized host and non-overlapping time slots for the at least one job task, based upon the detecting of the at least one anomaly. Next, the method includes generating, by the at least one processor based on a result of the identifying, at least one recommendation for optimizing the resource utilization with respect to performing the at least one job task. Next, the method includes transmitting, by the at least one processor to at least one user device, the at least one recommendation for optimizing the resource utilization.

In accordance with an exemplary embodiment, the job data includes at least one from among: first data that relates to a usage of hosts, second data that relates to job runtimes, third data that relates to a duration of the at least one job task, and fourth data that relates to associated logs.

In accordance with an exemplary embodiment, the login credentials include a user identity (ID) and a password.

In accordance with an exemplary embodiment, the set of parameters includes a folder identity (ID), a host machine name, a process name, a start time, an end time, and a utilization of resources associated with the at least one job task.

In accordance with an exemplary embodiment, the analyzing of the set of parameters is performed by using an artificial intelligence (AI) based model.

In accordance with an exemplary embodiment, the at least one recommendation includes a folder identity (ID), a process name, a list of current hosts, a list of suggested hosts, a list of recommended hosts, a list of start times, a list of end times, and a process distribution.

In accordance with an exemplary embodiment, the at least one anomaly includes a performance anomaly.

In accordance with an exemplary embodiment, the identifying of each of the at least one underutilized host and the non-overlapping time slots is based on a result of the analyzing of the set of parameters and a plurality of job tasks.

In accordance with an exemplary embodiment, the generating of the at least one recommendation is based on an analysis of the at least one underutilized host and the non-overlapping time slots.

According to another aspect of the present disclosure, a computing device configured to implement an execution of a method to generate recommendations to optimize resource utilization is disclosed. The computing device includes a processor; a memory; and a communication interface coupled to each of the processor and the memory. The processor may be configured to receive a recommendation request for at least one job task based upon successful validation of login credentials of a user. Next, the processor may be configured to generate a token to process the recommendation request. Next, the processor may be configured to fetch, from a server by using the token, job data for the at least one job task. Next, the processor may be configured to extract a set of parameters from the job data. Next, the processor may be configured to analyze the set of parameters. Next, the processor may be configured to detect a presence of at least one anomaly in the set of parameters based on the analysis of the set of parameters. Next, the processor may be configured to identify at least one underutilized host and non-overlapping time slots for the at least one job task based upon the detection of the at least one anomaly. Next, the processor may be configured to generate, based on a result of the identification, at least one recommendation for optimizing the resource utilization with respect to the at least one job task. Next, the processor may be configured to transmit, to at least one user device, the at least one recommendation for optimizing the resource utilization.

In accordance with an exemplary embodiment, the job data includes at least one from among: first data that relates to a usage of hosts, second data that relates to job runtimes, third data that relates to a duration of the at least one job task, and fourth data that relates to associated logs.

In accordance with an exemplary embodiment, the login credentials include a user identity (ID) and a password.

In accordance with an exemplary embodiment, the set of parameters includes a folder identity (ID), a host machine name, a process name, a start time, an end time, and a utilization of resources associated with the at least one job task.

In accordance with an exemplary embodiment, the analysis of the set of parameters is performed by using an artificial intelligence (AI) based model.

In accordance with an exemplary embodiment, the at least one recommendation includes a folder ID, a process name, a list of current hosts, a list of suggested hosts, a list of recommended hosts, a list of start times, a list of end times, and a process distribution.

In accordance with an exemplary embodiment, the at least one anomaly includes a performance anomaly.

In accordance with an exemplary embodiment, the identification of each of the at least one underutilized host and the non-overlapping time slots is based on a result of the analysis of the set of parameters, and a plurality of job tasks.

In accordance with an exemplary embodiment, the generation of the at least one recommendation is based on an analysis of the at least one underutilized host and the non-overlapping time slots.

According to yet another aspect of the present disclosure, a non-transitory computer-readable storage medium storing instructions to generate recommendations to optimize resource utilization is disclosed. The instructions include executable code which, when executed by a processor, may cause the processor to receive a recommendation request for at least one job task based upon successful validation of login credentials of a user; generate a token to process the recommendation request; fetch, from a server by using the token, job data for the at least one job task; extract a set of parameters from the job data; analyze the set of parameters; detect a presence of at least one anomaly in the set of parameters based on a result of the analysis of the set of parameters; identify at least one underutilized host and non-overlapping time slots for the at least one job task based on upon the detection of the at least one anomaly; generate, based on a result of the identification, at least one recommendation for optimizing the resource utilization with respect to the at least one job task; and transmit, to at least one user device, the at least one recommendation for optimizing the resource utilization.

In accordance with an exemplary embodiment, the job data includes at least one from among: first data that relates to a usage of hosts, second data that relates to job runtimes, third data that relates to a duration of the at least one job task, and fourth data that relates to associated logs.

In accordance with an exemplary embodiment, the login credentials include a user identity (ID) and a password.

In accordance with an exemplary embodiment, the set of parameters includes a folder identity (ID), a host machine name, a process name, a start time, an end time, and a utilization of resources associated with the at least one job task.

In accordance with an exemplary embodiment, the analysis of the set of parameters is performed by using an artificial intelligence (AI) based model.

In accordance with an exemplary embodiment, the at least one recommendation includes a folder ID, a process name, current hosts, suggested hosts, recommended hosts, start times, end times, and a process distribution.

In accordance with an exemplary embodiment, the at least one anomaly includes a performance anomaly.

In accordance with an exemplary embodiment, the identification of each of the underutilized host and the non-overlapping time slots is based on a result of the analysis of the set of parameters and a plurality of job tasks.

In accordance with an exemplary embodiment, the generation of the at least one recommendation is based on an analysis of the at least one underutilized host and the non-overlapping time slots.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system to generate recommendations to optimize resource utilization, in accordance with an exemplary embodiment of the present disclosure.

FIG. 2 illustrates an exemplary diagram of a network environment to generate recommendations to optimize resource utilization, in accordance with an exemplary embodiment of the present disclosure.

FIG. 3 illustrates an exemplary system to generate recommendations to optimize resource utilization, in accordance with an exemplary embodiment of the present disclosure.

FIG. 4 illustrates an exemplary method flow diagram to generate recommendations to optimize resource utilization, in accordance with an exemplary embodiment of the present disclosure.

FIG. 5 illustrates an architecture of the system to generate recommendations to optimize resource utilization, in accordance with an exemplary embodiment of the present disclosure.

FIG. 6 illustrates a process flow diagram representing a method for generating recommendations to optimize resource utilization, in accordance with an exemplary embodiment of the present disclosure.

FIG. 7 illustrates a process flow diagram representing a method for anomaly detection and prediction, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Current solutions often focus on reporting and providing statistics but lack the ability to offer a futuristic view or actionable recommendations based on identified anomalies. Existing solutions only provide fragmented statistical data without any technology problem and solution or actionable insight for resource allocation for a large organization that owns a lot of resources belonging to different lines of business (LOB). Additionally, existing solutions are often scattered and tightly coupled with a specific framework, limiting their flexibility and applicability. Therefore, the existing solutions are not so reliable in terms of resource allocation and process scheduling.

To overcome the above-mentioned problems, there is a need for an automated solution that not only identifies issues in available resources but also recommends actions to prevent future problems and optimizes resource allocation. Thus, the present disclosure provides a system and method for generating recommendations to optimize resource utilization. In the present disclosure, at first, the system receives a recommendation request for at least one job task based upon successful validation of login credentials of a user. Further, the system generates a token based on the login credentials to process the recommendation request. Further, the system fetches a job data for the at least one job task using the token, from a server. Further, the system extracts a set of parameters from the job data. Further, the system analyzes the set of parameters. Further, the system detects a presence of one or more anomalies in the set of parameters based on the analysis of the set of parameters. Further, the system identifies one or more underutilized hosts and non-overlapping time slots for the at least one job task based upon the detection of the anomalies. Further, the system generates at least one recommendation for optimizing resource utilization with respect to the at least one job task. Further, the system transmits, to at least one user device, the at least one recommendation for optimizing resource utilization in response to the recommendation request. In this way, the system provides recommendations to optimize resource utilization.

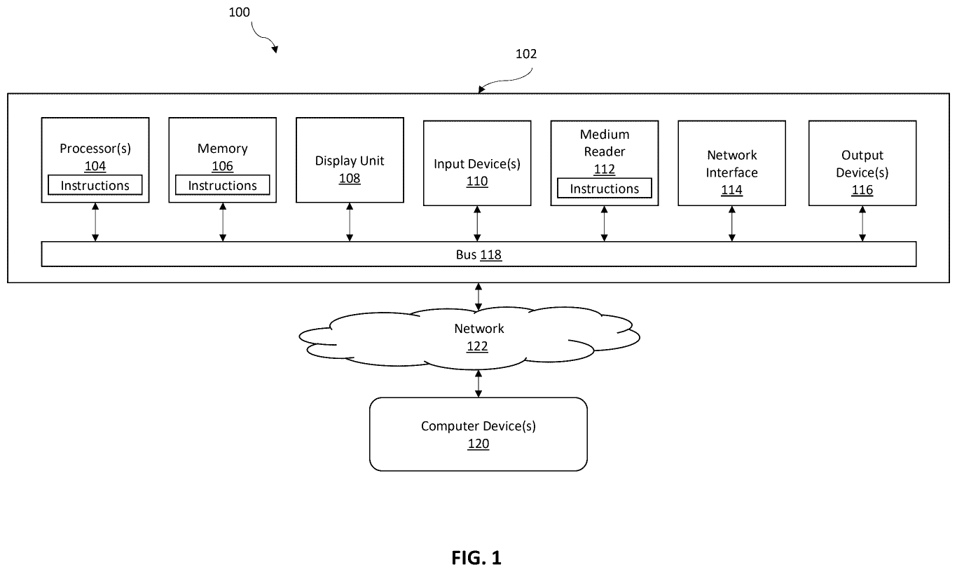

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to generate recommendations to optimize resource utilization.

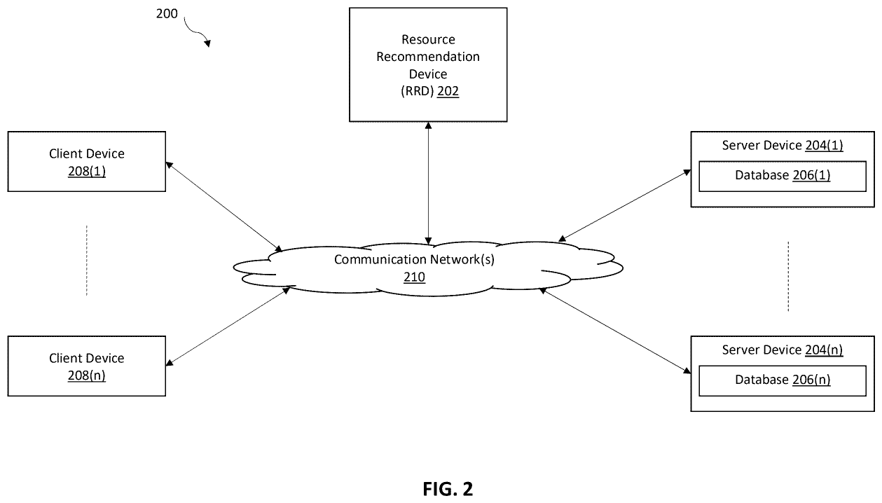

Referring to FIG. 2, a schematic of an exemplary network environment 200 to generate recommendations to optimize resource utilization is illustrated. In an exemplary embodiment, the method is executable on any networked computer platform, such as, for example, a personal computer (PC).

The method to generate recommendations to optimize resource utilization may be executed by a resource recommendation device (RRD) 202. The RRD 202 may be the same or similar to the computer system 102 as described with respect to FIG. 1. The RRD 202 may store one or more applications that may include executable instructions that, when executed by the RRD 202, cause the RRD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the RRD 202 itself, may be located in the virtual server(s) running in a cloud-based computing environment rather than being tied to one or more specific physical network computing devices. Also, the application(s) may be running in one or more virtual machines (VMs) executing on the RRD 202. Additionally, in one or more embodiments of this technology, virtual machine(s) running on the RRD 202 may be managed or supervised by a hypervisor.

In the network environment 200 of FIG. 2, the RRD 202 is coupled to a plurality of server devices 204(1)-204(n) that hosts a plurality of databases 206(1)-206(n), and also to a plurality of client devices 208(1)-208(n) via communication network(s) 210. A communication interface of the RRD 202, such as the network interface 114 of the computer system 102 of FIG. 1, operatively couples and communicates between the RRD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RRD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and RRDs that efficiently implement the method to generate recommendations to optimize resource utilization.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The RRD 202 may be a standalone device or integrated with one or more other devices or apparatuses, such as one or more of the server devices 204(1)-204(n), for example. In one particular example, the RRD 202 may include or be hosted by one of the server devices 204(1)-204(n), and other arrangements are also possible. Moreover, one or more of the devices of the RRD 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the RRD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to a plurality of recommendations for the resource optimization.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment, and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the RRD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the RRD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the RRD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the RRD 202, the server devices 204(1)-204(n), or the client devices 208(1)-208(n), for example, may be configured to operate as virtual instances on the same physical machine. In other words, one or more of the RRD 202, the server devices 204(1)-204(n), or the client devices 208(1)-208(n) may operate on the same physical device rather than as separate devices communicating through communication network(s) 210. Additionally, there may be more or fewer RRDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

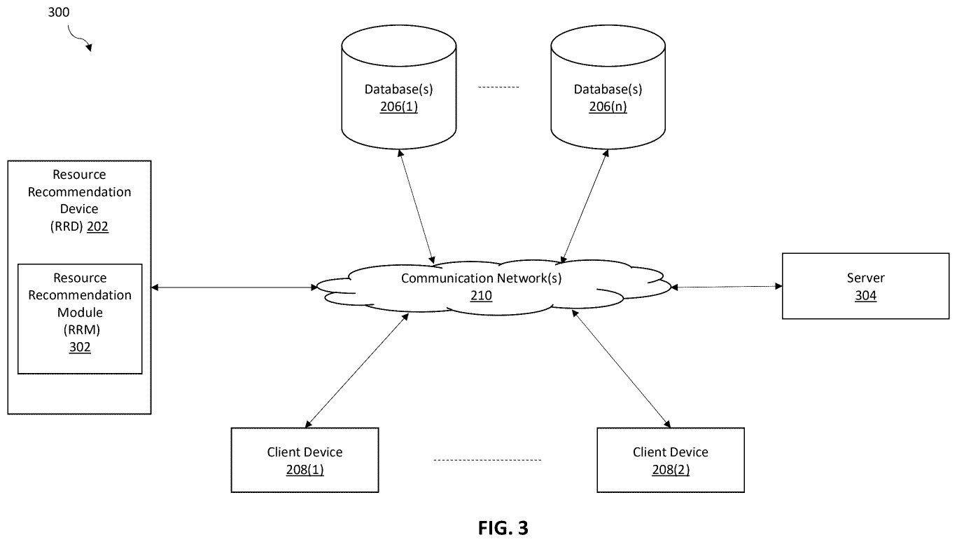

FIG. 3 illustrates an exemplary system to generate recommendations to optimize resource utilization, in accordance with an exemplary embodiment.

As illustrated in FIG. 3, the system 300 may include a resource recommendation device (RRD) 202 within which a resource recommendation module (RRM) 302 is embedded, a server 304, a database(s) 206(1) . . . 206(n), a plurality of client devices 208(1) . . . 208(2), and a communication network(s) 210.

According to exemplary embodiments, the system 300 may comprise the resource recommendation device (RRD) 202 including the RRM 302 may be connected to the server 304 and the database(s) 206(1) . . . 206(n) via the communication network(s) 210, but the disclosure is not limited thereto. The RRD 202 may also be connected to the plurality of client devices 208(1) . . . 208(2) via the communication network(s) 210, but the disclosure is not limited thereto. The database(s) 206(1) . . . 206(n) may include rule database.

In an embodiment, the RRD 202 is described and shown in FIG. 3 includes the RRM 302, although it may include other rules, policies, modules, databases, or applications, for example. As will be described below, the RRM 302 is configured to carry out a method for generating recommendations to optimize resource utilization.

An exemplary system 300 for enabling a mechanism for generating recommendations to optimize resource utilization by utilizing the network environment of FIG. 2 is shown as being executed in FIG. 3. Specifically, a first client device 208(1) and a second client device 208(2) are illustrated as being in communication with RRD 202. In this regard, the first client device 208(1) and the second client device 208(2) may be “clients” of the RRD 202 and are described herein as such. Nevertheless, it is to be known and understood that the first client device 208(1) and/or the second client device 208(2) need not necessarily be “clients” of the RRD 202, or any entity described in association therewith herein. Any additional or alternative relationship may exist between either or both of the first client device 208(1) and the second client device 208(2) and the RRD 202, or no relationship may exist.

Further, the RRD 202 is illustrated as being able to access one or more database(s) 206(1) . . . 206(n). The RRM 302 may be configured to access these repositories/databases to provide a method for generating recommendations to optimize resource utilization. In some embodiment, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein. The process may be executed via the communication network(s) 210, which may comprise plural networks as described above. For example, in an exemplary embodiment, either or both the first client device 208(1) and the second client device 208(2) may communicate with the RRD 202 via broadband or cellular communication. These embodiments are merely exemplary and are not limiting or exhaustive.

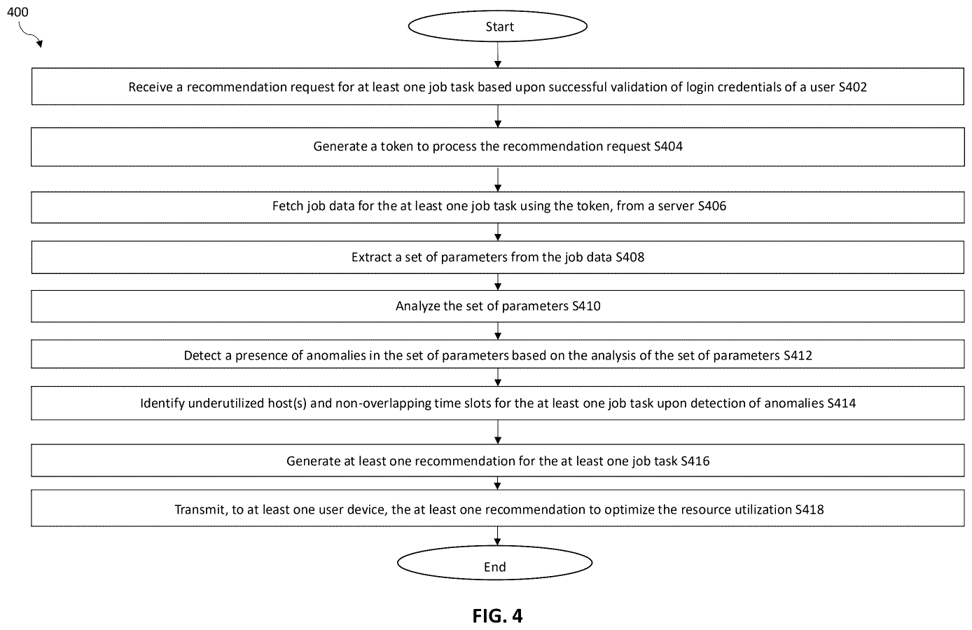

Referring to FIG. 4, an exemplary method 400 is shown for generating recommendations to optimize resource utilization, in accordance with an exemplary embodiment. In particular, the exemplary method 400 is shown for generating recommendations to optimize resource utilization.

As shown in FIG. 4, the method 400 begins following a need to optimize the resource allocation, process scheduling, and proactive maintenance of resources of an organization. The method 400 is implemented by at least one processor 104.

At step S402, the method 400 includes receiving, by the at least one processor 104, a recommendation request for at least one job task based upon successful validation of login credentials of a user. The login credentials may include, but are not limited to, a user identity (ID) and a password. The at least one job task may be one or more jobs performed by at least one resource of an organization.

The term “resource” refers to hardware or software assets required to perform computational tasks within a system or environment (such as any organization). The at least one resource may include but is not limited to servers or computers, software licenses, and/or storage resources.

The term “login credentials” herein may correspond to the information required to authenticate and verify the identity of a user attempting to access a secure system, service, or an application. A user identity (ID) is a unique identifier chosen by a user or assigned by a system administrator, which helps distinguish one user from another. Password refers to a confidential string of characters (e.g., letters, numbers, or symbols) known only to the user and used to prove their identity.

For example, a user may raise the recommendation request by using an application (e.g., a web executable interface or a web application) for the at least one job task after successful validation of login credentials (e.g., a username and a password) provided by the user. The application requests a token (also referred to as an access token) from an orchestrator application programming interface (API) using a client ID and a secret key provided by the application to process the recommendation request. The application may encrypt the client ID and the secret key while requesting the access token. Further, the orchestrator API validates the received encrypted client ID and the secret key and issues a token upon successful validation of the client ID and the secret key. The orchestrator API is communicably coupled with a server (e.g., an orchestrator server). The application uses the token to make authenticated API requests (e.g., the recommendation request for the at least one job task) to the orchestrator API.

It will be appreciated by the person skilled in the art that the aim here is to create a system that provides recommendations on resource allocation and optimization.

At step S404, the method includes generating, by the at least one processor 104, a token to process the recommendation request.

The term “token” herein may correspond to a piece of data generated by the server (e.g., the orchestrator server) to authenticate a specific request. The token serves as a form of authentication and as an authorization mechanism. It ensures that the user making the recommendation request is legitimate and has the necessary permission to access the requested resource or perform the requested action.

In an exemplary implementation, the method includes storing, by the at least one processor 104, the token in a database after validating the client ID and the secret key and utilizing the token to make authenticated API request(s) to the server (or the orchestrator API/the orchestrator server) for the at least one job task.

At step S406, the method includes fetching, from the server by the at least one processor 104 using the token, job data for the at least one job task. The job data may include at least one from among: first data that relates to a usage of hosts, second data that relates to job runtimes, third data that relates to a duration of the at least one job task, and fourth data that relates to associated logs.

The term “job data” refers to information related to the at least one job task being processed by the system. The term job represents a specific task or set of tasks that need to be executed by a computer system.

Usage of hosts refers to the use of resources such as computers (e.g., machines) or servers (e.g., hosts) during the execution of at least one job. It may include metrics such as a central processing unit (CPU) usage, a memory usage, a disk space usage, a network usage, and other relevant resource utilization metrics. Usage of licenses pertains to the utilization of software licenses required to run specific applications or services. It may include details about the number of licenses being used or unused by the hosts, license expiration dates, and any other licensing terms or restrictions. Logs refer to records generated by the system during the execution of the at least one job task. Such logs capture various activities and events, providing a chronological record of operations. These logs may include information such as job start times and end times, errors encountered, warnings, and other relevant operational data.

At step S408, the method includes extracting, by the at least one processor 104, a set of parameters from the job data. The set of parameters may include any one or more of a folder identity (ID), a host machine name, a process name, a start time, an end time, and a utilization of resources associated with the at least one job task.

The folder ID serves as a unique identifier for organizing and accessing job-related files and typically identifies the location or directory where the job data or outputs are stored. The host machine name refers to a name or an identifier of the machine (e.g., a server or a computer) where the job was executed or is currently running. It helps in tracking which specific hardware resources are utilized for a particular job. The process name identifies the specific process or application that is being executed as a part of the job. It provides insight into the type of task or operation being performed. The start time indicates a timestamp when the job starts its execution. It is crucial for monitoring job progress, scheduling, and analyzing performance metrics. The end time specifies a timestamp when the job completes its execution. It marks the moment when the job finishes its task, allowing for the calculation of a job duration and overall system efficiency.

Utilization of resources associated with the at least one job task may include metrics that quantify how resources were utilized during the execution of the job. It may encompass machine usage, resource consumption (e.g., consumption of resources due to multiple job tasks, processes, or hosts), frequency of execution and other relevant metrics.

At step S410, the method includes analyzing, by the at least one processor 104, the set of parameters. The set of parameters may be analyzed by using an artificial intelligence (AI) based model.

At step S412, the method includes detecting, by the at least one processor 104, a presence of one or more anomalies in the set of parameters based on a result of the analyzing of the set of parameters. The anomalies may include performance anomalies.

In an exemplary implementation, the anomalies may include at least one from among the performance anomalies, behavioral anomalies, configuration anomalies, and predictive anomalies. In an example, the performance anomalies are anomalies affecting a system, and the determination of such anomalies may be based on a corresponding drop in throughput and usage patterns. For example, unusually high CPU utilization on a host may indicate a resource-intensive application or potential denial-of-service (DoS). Behavioral anomalies reflect unexpected changes in user actions or system actions. Behavioral anomalies may involve how a system behaves or responds to inputs during unexpected changes. Behavioral anomalies may include unexpected system outputs that differ from typical behavior. For example, unexpected process behavior such as new or unusual processes starting on a host can signal unauthorized access or compromised systems. Configuration anomalies may include changes done to host settings or configurations that deviate from established baselines may lead to security vulnerabilities or performance issues. Predictive anomalies may include resource usage forecast failures. For example, inaccurate forecast resource usage (e.g., usages of CPU, memory, disk space of a host) can result in resource shortages or overprovisioning.

As used herein, anomalies refer to unexpected or unusual deviations in the utilization or performance of resources of the organization. In an example, the lowest operational performance of the machine or the process may be considered as an anomaly related to the resource.

In an exemplary implementation, the at least one processor 104, via the AI-based model, continuously monitors resource utilization metrics and compares current utilization levels against historical data or predefined thresholds. If there is a significant deviation (e.g., a sudden spike or drop) that exceeds normal variations, the at least one processor may flag the deviation as an anomaly. For the detection of configuration anomalies, the system maintains a baseline of expected configurations. It checks for changes or discrepancies (e.g., including but not limited to unauthorized modifications to configurations and outdated software versions) that could indicate potential security risks or operational issues.

At step S414, the method includes identifying, by the at least one processor 104, one or more underutilized hosts and non-overlapping time slots for the at least one job task based on upon the detection of the anomalies. The underutilized host(s) and non-overlapping time slots are identified based on the analysis of the set of parameters and a plurality of job tasks.

For example, the at least one processor 104 may filter hosts with a predefined criterion (e.g., filter hosts having specific initials in their names). Further, the at least one processor 104 identifies valid hosts from groups of various jobs that satisfy the predefined criterion. The at least one processor 104 may identify the plurality of job tasks and then check runtimes for the plurality of job tasks. In an example, the plurality of job tasks may correspond to tasks performed on the plurality of hosts in a computing environment. The at least one processor 104 further checks whether job times (also referred to as job time slots) within each group are non-overlapping to avoid scheduling conflicts for the at least one job task. For example, in a group, job time slots for a process are identified as 08:00-09:00, 09:00-10:00, and 11:00-12:00, which are considered non-overlapping time slots as no slot is overlapping with another slot for the same process. Further, the at least one processor 104 displays recommendations for those hosts where the processes which are already running do not overlap with other processes that need to be optimally moved to the underutilized host(s).

The at least one processor 104 identifies hosts that are underutilized or in ideal condition from a list of valid hosts and determines them as ‘underutilized host(s)’. For example: from a list of five hosts, “IA-Host1” might be selected as least used host by the at least one processor 104.

At step S416, the method includes generating, by the at least one processor 104, at least one recommendation for resource optimization with respect to the at least one job task. The at least one recommendation may include any one or more of a folder ID, a process name, a list of current hosts, a list of suggested hosts, a list of recommended hosts, a list of start times, a list of end times, and a process distribution. The at least one recommendation is generated based on the analysis of the underutilized host(s) and the non-overlapping time slots.

The current hosts provide information about the current machines or servers where the job is currently being carried out or has been executed. The suggested hosts recommend alternative hosts or machines based on current resource availability, performance metrics, and workload distribution across the system. The process distribution recommends a way to distribute processes across available resources (such as machines or servers) to optimize the overall performance and resource utilization.

At step S418, the method includes transmitting, by the at least one processor 104 to at least one user device, the at least one recommendation for optimizing resource utilization. The at least one recommendation is transmitted in response to the recommendation request received from the authorized user. The at least one recommendation includes the folder ID, the process name, the list of current hosts, the list of suggested hosts, the list of recommended hosts, the list of start times, the list of end times, and the process distribution. The at least one user device may be selected from but is not limited to, a smartphone, a tablet, a laptop, a wearable computing device, and a computer.

In an exemplary implementation, the at least one recommendation is transmitted to the at least one user device to allow the user to view the at least one recommendation and take appropriate action on such recommendation.

The examples provided hereinbelow are for illustrative purposes to aid in understanding the invention and are not intended to limit the scope of the claims. A job data example is provided below:

```
jobs=[ {‘OrganizationUnitId’: 1, ‘HostMachineName’: ‘IA-Host1’, ‘ReleaseName’:
‘ProcessA’, ‘StartTime’: ‘2024-06-18 08:00:00’, ‘EndTime’: ‘2024-06-18 09:00:00’,
‘Utilization’:50},
  {‘OrganizationUnitId’: 1, ‘HostMachineName’: ‘IA-Host2’, ‘ReleaseName’: ‘ProcessA’,
‘StartTime’: ‘2024-06-18 09:00:00’, ‘EndTime’: ‘2024-06-18 10:00:00’, ‘Utilization’: 70},
  {‘OrganizationUnitId’: 1, ‘HostMachineName’: ‘IA-Host3’, ‘ReleaseName’: ‘ProcessB’,
‘StartTime’: ‘2024-06-18 10:00:00’, ‘EndTime’: ‘2024-06-18 11:00:00’, ‘Utilization’: 30},
  {‘OrganizationUnitId’: 1, ‘HostMachineName’: ‘IA-Host1’, ‘ReleaseName’: ‘ProcessA’,
‘StartTime’: ‘2024-06-18 11:00:00’, ‘EndTime’: ‘2024-06-18 12:00:00’, ‘Utilization’: 60}]
```

First, job data is retrieved. In an embodiment, the job data contains information about processes running on different hosts belonging to an organization. Next, features or a set of parameters are extracted from the job data. The features may include any one or more of a folder identity (ID), a host machine name, a process name, a start time, an end time, and utilization of resources associated with at least one job from a plurality of jobs.

Next, hosts are filtered based on their names that are retrieved from the set of parameters. For example, hosts having “IA” in their names may be filtered out.

Next, groups of jobs are created based on the folder ID and process name to analyze multiple jobs together. Examples of groups created may be provided as follows:
Group 1: Folder ID 1 and ProcessA;
Group 2: Folder ID 1 and ProcessB.

Next, at least one valid host is identified from a list of hosts based on compliance with predefined filter criteria. For example: valid hosts for Group 1 (ProcessA) might be “IA-Host1”, and “IA-Host2”.

Next, check if timing of jobs within each of said groups (e.g., groups of jobs) are non-overlapping with each other to avoid scheduling conflicts for the plurality of jobs. For example, the system checks whether job time slots within each group are non-overlapping time slots to avoid scheduling conflicts. In an example, for Group 1 (ProcessA), job time slots are 08:00-09:00, 09:00-10:00, and 11:00-12:00, which are determined as non-overlapping time slots.

Next, the least used hosts or underutilized hosts are selected from a plurality of valid hosts based on analysis of the set of parameters. The selection of the least used host or underutilized host is performed to distribute job processes among the selected least used hosts. For example, “IA-Host1” and “IA-Host2” may be selected as the least used host from the plurality of valid hosts.

Next, the job processes are distributed among the selected least used hosts and then the system calculates their total utilization during the specified period. For example: the ProcessA may be distributed among “IA-Host1” and “IA-Host2” to optimize the processing of the processA.

At last, at least one recommendation is generated for optimizing resource utilization with respect to the job processes. The at least one recommendation may include any one or more of the folder ID, the process name, current hosts, suggested hosts, start times, end times, and the process distribution. Example of the at least one recommendation is provided as follows:

```
json
  {
    ‘folder_id’: 1,
    ‘process_name’: ‘ProcessA’,
    ‘process_utilization’: 180, # Total utilization for ProcessA
    ‘current_hosts': {‘IA-Host1’: ′50%’, ‘IA-Host2’: ‘70%’},
    ‘suggested_hosts': {‘IA-Host1’: ‘50%’, ‘IA-Host2’: ‘70%’},
    ‘start_times': [‘2024-06-18 08:00:00’, ‘2024-06-18 09:00:00’, ‘2024-06-18
11:00:00’],
    ‘end_times': [‘2024-06-18 09:00:00’, ‘2024-06-18 10:00:00’, ‘2024-06-18
12:00:00’],
    ‘process_distribution’: [‘IA-Host1’, ‘IA-Host2’]
  }
```

In another exemplary implementation, the method includes receiving, by the at least one processor 104, feedback from the user device in response to the at least one recommendation. The feedback may include asking the user to provide inputs on the at least one recommendation for the at least one job task (for example, good or bad for the generated recommendation). The method may include storing, by the at least one processor 104, the feedback received from the user in response to the at least one recommendation into the database. The feedback may be further used to provide better recommendation(s) for resource balancing. In this way, the present disclosure provides the best possible recommendation(s) to ensure optimization of resources.

In an exemplary implementation, the method includes generating, by the at least one processor 104, a detailed message related to the absence of a recommendation in the event of the absence of anomalies (e.g., if no anomalies are detected, the system returns no recommendations) in the set of parameters based on the analysis of the set of parameters. In another exemplary implementation, the at least one processor 104 may transmit a notification over a user interface (UI) of the application to notify the user in case the presence of anomalies is detected in the set of parameters. In an exemplary implementation, the notification may be customized to be delivered to the user via various channels, such as email, short message service (SMS), or even as a push notification from the application, depending on the system's capabilities.

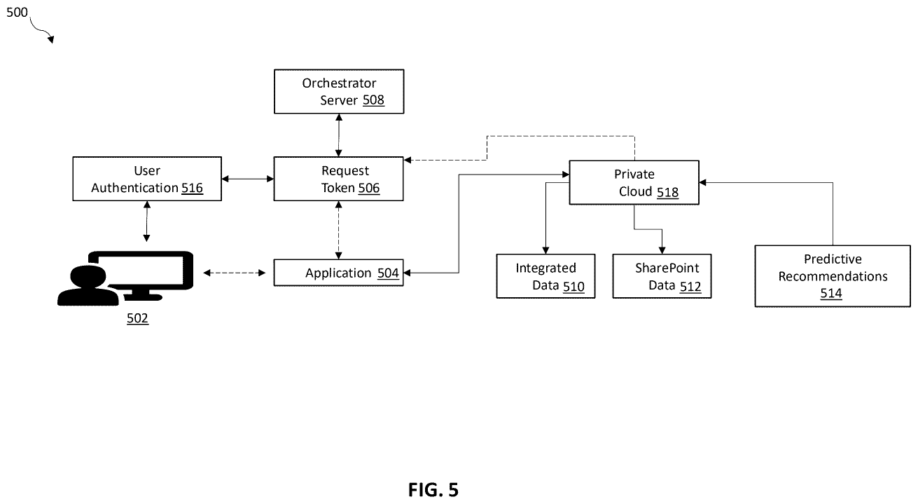

FIG. 5 illustrates an architecture diagram of a system to generate recommendations to optimize resource utilization, in accordance with an exemplary embodiment. As illustrated in FIG. 5, the process flow 500 begins with receiving a recommendation request for at least one job task from a user 502 that interacts with an application 504 (e.g., a mobile application or a web application) to provide login credentials (e.g., a user identity (ID) and a password) for the authentication 516. Further, the application 504 requests a token 506 or an access token 506 from an orchestrator application programming interface (API) using a client ID and a secret key provided by the application 504 to process the recommendation request. The application 504 encrypts the client ID and the secret key. Further, the orchestrator API validates the credentials and issues the token 506 upon successful validation of the client ID and the secret key. The orchestrator API is communicably coupled with a server 508 (e.g., an orchestrator server 508). The application 504 uses the token 506 to make authenticated API requests to the orchestrator API. The orchestrator API provides a requested data or a job data (e.g., usage of machines or hosts, job runtimes, duration of the at least one job, logs, etc.) for at least one job task using the token 506, from the orchestrator server 508.

Further, the orchestrator API is communicably coupled with an intranet data (also referred to as integrated data) 510 and a shared point data 512 via a private cloud platform 518. The intranet data 510 and the shared point data 512 are communicably coupled with the private cloud 518. Intranet data 510 is utilized for dynamic updates of the system. For example, if the user 502 has changed their line of business (LOB), the intranet data 510 is immediately updated to reflect these changes. This ensures that all insights and information provided to the user 502 are updated, accurate, and eliminates the risk of outdated or incorrect data. The shared point data 512 includes detailed mappings of users, their associated LOBs, and their bot processes. This comprehensive mapping is continuously updated, ensuring that any changes in user roles or responsibilities are accurately reflected in real-time. Thereafter, predictive recommendations 514 are generated to optimize the resource utilization by orchestrator server 508. The recommendation is displayed to the user over the application 504 to allow the user 502 to view the recommendations 514 which helps in the optimization of resource allocation.

In another exemplary implementation, the user 502 provides the login credentials over a user interface (UI) of an application and further provides input by selecting at least one option (e.g., tenant) from a menu displayed over the UI (e.g., a license menu). The at least one option may include selection of the tenant, line of business (LOB), sub-LOB, a start date, and an end date. Further, the at least one processor 104 is configured to provide the user inputs along with a fetched license data to an artificial intelligence (AI) based model. Further, the AI based model is configured to generate at least one recommendation and render it over the UI of the application to display the at least one recommendation related to prediction and anomaly results. For example: in a process, an anomaly is detected in Studio X, then the current recommendation for the anomaly is to consider consolidating tasks or reducing the number of machines or hosts to optimize resource usage and minimize licensing costs.

It would be appreciated by the person skilled in the art that the disclosed method offers a full-circle, adaptable, and intelligent solution for implementing a method for generating recommendations to optimize resource utilization.

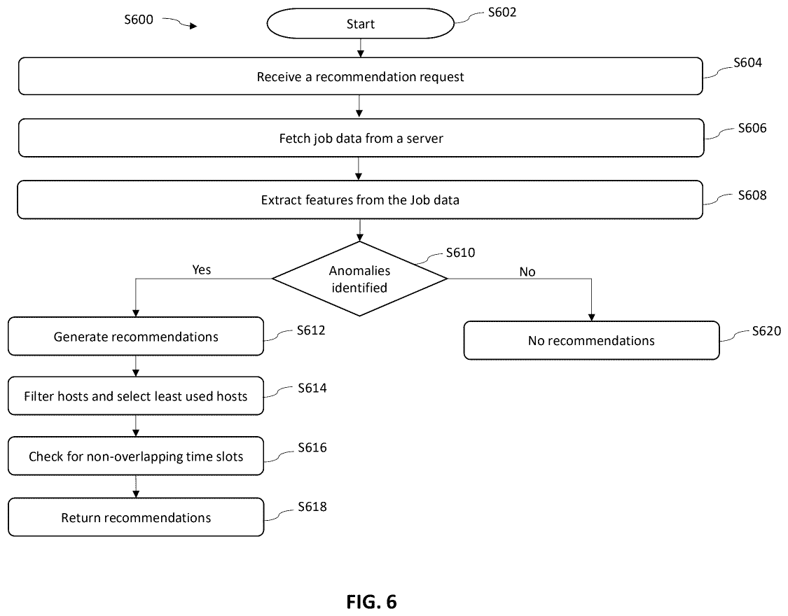

FIG. 6 illustrates a process flow diagram representing a method for generating recommendations to optimize resource utilization, in accordance with an exemplary embodiment of the present disclosure.

As illustrated in FIG. 6, the process flow S600 begins at step S602. At step S604, a recommendation request is received for at least one job task based upon successful validation of login credentials provided by a user via an application. At step S606, job data is fetched for the at least one job task using a token, from a server (e.g., an orchestrator or an orchestrator server). In an exemplary implementation, the system fetches the job data via an orchestrator uniform resource locator (URL) using the token generated based on the credentials such as client identity and secret key.

At step S608, features (also referred to as a set of parameters that relate to the job data) are extracted from the job data. The features may include a folder identity (ID), a host machine name, a process name, a start time, an end time, and a utilization of resources associated with the at least one job task.

At step S610, at least one processor 104 checks for the presence of one or more anomalies in the set of parameters based on an analysis of the set of parameters. A decision is made based on the anomalies identified in the set of parameters. If anomalies are identified, then the process flow S600 proceeds to the next step S612. If anomalies are not identified, the system returns “no recommendations” in step S620. Further, at step S612, recommendations are generated based on the extracted job features and host utilization data. At step S614, the at least one process identifies least-used hosts based on filtering hosts and selects the least-used hosts or underutilized hosts based on their utilization metrics. At step S616, the at least one process further checks for non-overlapping time slots among jobs to ensure that the process may be distributed efficiently between the least used hosts. At step S618, if non-overlapping time slots are found, the system returns the generated recommendations, including suggested hosts and job details to the application to display the recommendations to the user.

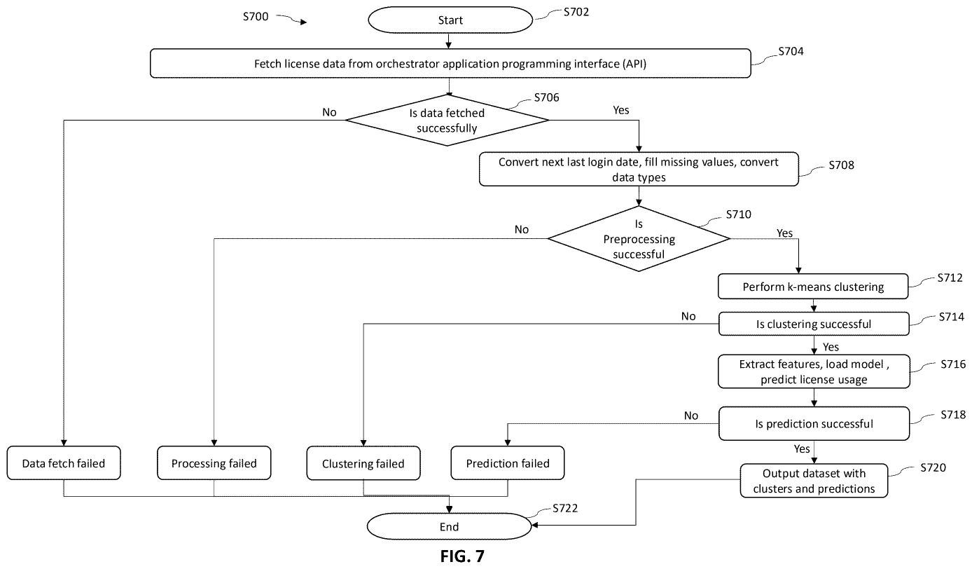

FIG. 7 illustrates a process flow diagram representing a method for anomaly detection and prediction, in accordance with an exemplary embodiment of the present disclosure.

As illustrated in FIG. 7, the process flow S700 begins at step S702. At step S704, license data is fetched via a user interface (UI) path using an orchestrator application programming interface (API). The license data may include license usage across a plurality of resources (e.g., hosts or computers belonging to an organization that utilizes at least one license) of an organization. At step S706, the at least one process determines whether or not data is fetched successfully, from the orchestrator API (e.g., an orchestrator or an orchestrator server). If the data fetch is successful, then the process flow S700 proceeds to data preprocessing at step S708. If the data fetch is not successful, the process flow S700 returns an error (e.g., data fetch failed) and ends the process. At step S708, the retrieved data undergoes several preprocessing steps mentioned as follows: a) convert “last login date” to “date time format”, b) fill missing “machines count” with zero (0), c) convert “is licensed” and “is external licensed” to integers, d) fill missing “active robot identity (ID)” with zero (0). If preprocessing is successful, then the process flow S700 proceeds to clustering at step S710. If preprocessing is not successful, the process flow S700 returns an error (e.g., processing failed) and ends the process. At step S712, the at least one processor 104 applies K-means clustering to the preprocessed data using features such as a machine count, licensed, external licensed, and active robot ID. At step S714, the at least one processor 104 checks the success of clustering. If clustering is successful, then the process flow S700 proceeds to license usage prediction at step S716. If clustering is not successful, the process flow S700 returns an error (e.g., clustering failed) and ends the process. At step S716, the at least one processor 104 extracts the features for prediction, including, but not limited only to, the machine count, licensed, external licensed, active robot ID, and a cluster label. At step S718, the at least one processor 104 determines the success of prediction. If the prediction is successful, then the process flow S700 proceeds to return results at step S720. If the prediction is not successful, then the process flow S700 returns an error, i.e., “prediction failed,” and ends the process. At step S720, a final dataset containing cluster labels and license usage predictions is generated. At last, the method terminates at step S722.

The present disclosure provides numerous advantages as given below. The present disclosure provides a method for generating recommendations to optimize resource utilization. The method provides recommendations for distributing processes across available resources to balance the load and prevent overutilization of the resources. The method ensures optimal start and end times for processes to reduce peak loads and ensure smooth operations. The method provides recommendations for preventive maintenance based on predicted anomalies and historical patterns. The method analyzes structured data to offer meaningful recommendations to both technical and business teams. These recommendations optimize technological resources such as servers and bots, leading to significant cost savings and efficient resource management. The system disclosed provides a framework agnostic, capable of connecting to any framework an application programming interface (API) with few custom configuration changes. This flexibility allows the system to be utilized across different platforms and systems, providing a unified and versatile tool for managing automation processes.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to generate recommendations to optimize resource utilization is disclosed. The instructions include executable code which, when executed by a processor 104, may cause the processor 104 to receive a recommendation request for at least one job task based upon successful validation of login credentials of a user; generate a token to process the recommendation request; fetch, from a server by using the token, job data for the at least one job task; extract a set of parameters from the job data; analyze the set of parameters; detect a presence of one or more anomalies in the set of parameters based on a result of the analysis of the set of parameters; identify one or more underutilized hosts and non-overlapping time slots for the at least one job task based upon the detection of the anomalies; generate at least one recommendation for optimizing resources with respect to the at least one job task; and transmit, to at least one user device, the at least one recommendation for optimizing the resource utilization.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for generating recommendations to optimize resource utilization, the method being implemented by at least one processor, the method comprising:
receiving, by the at least one processor, a recommendation request for at least one job task based upon successful validation of login credentials of a user;
generating, by the at least one processor, a token to process the recommendation request;
fetching, from a server by the at least one processor using the token, job data for the at least one job task;
extracting, by the at least one processor, a set of parameters from the job data;
analyzing, by the at least one processor, the set of parameters;
detecting, by the at least one processor, a presence of at least one anomaly in the set of parameters based on a result of the analyzing of the set of parameters;
identifying, by the at least one processor, at least one underutilized host and non-overlapping time slots for the at least one job task based upon the detecting of the at least one anomaly;
generating, by the at least one processor based on a result of the identifying, at least one recommendation for optimizing the resource utilization with respect to performing the at least one job task; and
transmitting, by the at least one processor to at least one user device, the at least one recommendation for optimizing the resource utilization.

2. The method as claimed in claim 1, wherein the job data comprises at least one from among: first data that relates to a usage of hosts, second data that relates to job runtimes, third data that relates to a duration of the at least one job task, and fourth data that relates to associated logs.

3. The method as claimed in claim 1, wherein the login credentials comprise a user identity (ID) and a password.

4. The method as claimed in claim 1, wherein the set of parameters comprises a folder identity (ID), a host machine name, a process name, a start time, an end time, and a utilization of resources associated with the at least one job task.

5. The method as claimed in claim 1, wherein the analyzing of the set of parameters is performed by using an artificial intelligence (AI) based model.

6. The method as claimed in claim 1, wherein the at least one recommendation comprises a folder identity (ID), a process name, a list of current hosts, a list of suggested hosts, a list of recommended hosts, a list of start times, a list of end times, and a process distribution.

7. The method as claimed in claim 1, wherein the at least one anomaly comprises a performance anomaly.

8. The method as claimed in claim 1, wherein the identifying of each of the at least one underutilized host and the non-overlapping time slots is based on a result of the analyzing of the set of parameters and a plurality of job tasks.

9. The method as claimed in claim 1, wherein the generating of the at least one recommendation is based on an analysis of the at least one underutilized host and the non-overlapping time slots.

10. A computing device configured to generate recommendations to optimize resource utilization, the computing device comprising:
a processor;
a memory; and
a communication interface coupled to each of the processor and the memory,
wherein the processor is configured to:
receive, via the communication interface, a recommendation request for at least one job task based upon successful validation of login credentials of a user;
generate a token to process the recommendation request;
fetch, from a server by using the token, a job data for the at least one job task;
extract a set of parameters from the job data;
analyze the set of parameters;
detect a presence of at least one anomaly in the set of parameters based on the analysis of the set of parameters;
identify at least one underutilized host and non-overlapping time slots for the at least one job task based upon the detection of the at least one anomaly;
generate, based on a result of the identification of the at least one underutilized host and the non-overlapping time slots, at least one recommendation for optimizing the resource utilization with respect to performing the at least one job task; and
transmit, to at least one user device via the communication interface, the at least one recommendation for optimizing the resource utilization.

11. The computing device as claimed in claim 10, wherein the job data comprises at least one from among: first data that relates to a usage of hosts, second data that relates to job runtimes, third data that relates to a duration of the at least one job task, and fourth data that relates to associated logs.

12. The computing device as claimed in claim 10, wherein the login credentials comprise a user identity (ID) and a password.

13. The computing device as claimed in claim 10, wherein the set of parameters comprises a folder identity (ID), a host machine name, a process name, a start time, an end time, and a utilization of resources associated with the at least one job task.

14. The computing device as claimed in claim 10, wherein the analysis of the set of parameters is performed by using an artificial intelligence (AI) based model.

15. The computing device as claimed in claim 10, wherein the at least one recommendation comprises a folder identity (ID), a process name, a list of current hosts, a list of suggested hosts, a list of recommended hosts, a list of start times, a list of end times, and a process distribution.

16. The computing device as claimed in claim 10, wherein the at least one anomaly comprises a performance anomaly.

17. The computing device as claimed in claim 10, wherein the identification of each of the at least one underutilized host and the non-overlapping time slots is based on a result of the analysis of the set of parameters and a plurality of job tasks.

18. The computing device as claimed in claim 10, wherein the generation of the at least one recommendation is based on an analysis of the at least one underutilized host and the non-overlapping time slots.

19. A non-transitory computer readable storage medium storing instructions to generate recommendations to optimize resource utilization, the storage medium comprising executable code which, when executed by a processor, causes the processor to:
receive a recommendation request for at least one job task based upon successful validation of login credentials of a user;
generate a token to process the recommendation request;
fetch, from a server by using the token, a job data for the at least one job task;
extract a set of parameters from the job data;
analyze the set of parameters;
detect a presence of at least one anomaly in the set of parameters based on a result of the analysis of the set of parameters;
identify at least one underutilized host and non-overlapping time slots for the at least one job task based upon the detection of the at least one anomaly;
generate, based on a result of the identification of the at least one underutilized host and the non-overlapping time slots, at least one recommendation for optimizing the resource utilization with respect to performing the at least one job task; and
transmit, to at least one user device, the at least one recommendation for optimizing the resource utilization.

20. The storage medium as claimed in claim 19, wherein the generation of the at least one recommendation is based on an analysis of the at least one underutilized host and the non-overlapping time slots.
